(19) United States
(12) Patent Application Publication
(10) Pub. No.: US 2007/0014351 A1
(43) Pub. Date: Jan. 18, 2007

(54) Method and apparatus for encoding and decoding FGS layer using reconstructed data of lower layer

(75) Inventors: Bae-keun Lee, Bucheon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/484,645

(22) Filed: Jul. 12, 2006

Related U.S. Application Data
(60) Provisional application No. 60/698,004, filed on Jul. 12, 2005.

(30) Foreign Application Priority Data
Sep. 22, 2005 (KR) 10-2005-0088354

(51) Int. Cl. H04N 11/04; H04B 1/66

(52) U.S. Cl. 375/240.03; 375/240.1; 375/240.27

(57) ABSTRACT

A method and apparatus for encoding and decoding a fine granularity scalable (FGS) layer using reconstructed data of a lower layer. The method includes encoding the FGS layer in a multilayer video signal includes reconstructing original data of the lower layer that corresponds to a low-pass frame represented by the FGS layer, obtaining a residual between original data of the enhancement layer and the reconstructed original data of the lower layer, and generating an FGS layer bitstream through the processes of quantizing the residual and performing an entropy coding of the quantized residual.

### CROSS-REFERENCE TO RELATED APPLICATIONS

This application claims priority from Korean Patent Application No. 10-2005-0088354, filed on Sep. 22, 2005 in the Korean Intellectual Property Office, and U.S. Provisional Patent Application No. 60/698,004 filed on Jul. 12, 2005, the disclosures of which are incorporated herein by reference in their entireties.

### BACKGROUND OF THE INVENTION

1. Field of the Invention

The present invention relates to the video encoding and decoding, and more particularly to a method and apparatus for encoding and decoding a fine grain SNR scalable layer using reconstructed data of a lower layer.

2. Description of the Prior Art

Since multimedia data is large, mass storage media and wide bandwidths are required for storing and transmitting the data. Accordingly, compression coding techniques are required to transmit the multimedia data. Among multimedia compression methods, video compression methods can be classified into lossy/lossless compression, intraframe/interframe compression, and symmetric/asymmetric compression, depending on whether source data is lost, whether compression is independently performed for respective frames, and whether the same time is required for compression and reconstruction, respectively. In the case where frames have diverse resolutions, the corresponding compression is scalable compression.

The purpose of conventional video coding is to transmit information that is optimized for a given transmission rate. However, in a network video application such as video streaming over the Internet, the performance of the network is not constant, but varies according to circumstances, and thus a flexible coding is required in addition to the optimized coding.

Scalability refers to a coding technique that enables a decoder to selectively decode a base layer and an enhancement layer according to processing conditions and network conditions. In particular, fine granularity scalable (FGS) methods encode the base layer and the enhancement layer, and after the encoding is performed the enhancement layer may not be transmitted or decoded, depending on the network transmission efficiency or the state of a decoder side. Accordingly, data can be properly transmitted according to the network transmission rate.

FIG. 1 illustrates an example of a scalable video codec using a multilayer structure. In this video codec, the base layer is defined as Quarter Common Intermediate Format (QCIF) at 15 Hz (frame rate), the first enhancement layer is defined as Common Intermediate Format (CIF) at 30 Hz, and the second enhancement layer is defined as Standard Definition (SD) at 60 Hz. If a CIF 0.5 Mbps stream is required, the CIF₁₃ 30 Hz₁₃0.7 M bit stream is truncated so that its bit rate becomes 0.5 Mbps. In this method, spatial and temporal signal-to-noise ratio (SNR) scalability can be obtained.

As shown in FIG. 1, it is usually true that frames (e.g., 10, 20 and 30) in respective layers, which have the same temporal position, have images similar to one another. Accordingly, a method of predicting the texture of the current layer and encoding the difference between the predicted value and the actual texture value of the current layer has been proposed. In the Scalable Video Mode 3.0 of ISO/IEC 21000-13 Scalable Video Coding (hereinafter referred to as “SVM 3.0”), such a method is called intra-BL prediction.

According to SVM 3.0, in addition to inter prediction and directional intra prediction used for prediction of blocks or macroblocks that constitute the current frame in the existing H.264 method, a method of predicting the current block by using the correlation between the current block and a corresponding lower-layer block has been adopted. This prediction method is called an intra-base layer (intra-BL) prediction, and a mode for performing an encoding using such a prediction method is called an “intra-BL mode”.

FIG. 2 is a view schematically illustrating the three above-described prediction methods. First, \textcircled{1}, an intra prediction with respect to a certain macroblock 14 of the current frame 11 is performed. Second, \textcircled{2}illustrates an inter prediction using a frame 12 that is at a temporal position different from that of the current frame 11. Third, \textcircled{3}illustrates an intra-BL prediction using texture data of an area 16 of a base-layer frame 13 that corresponds to the macroblock 14.

In FGS, residual data can be obtained with reference to residual data of a lower layer. This reduces the amount of data that has to be transmitted. Accordingly, it is necessary to flexibly determine what residual data is to be used or what data should be used to obtain the residual in accordance with an attribute of a frame to which the FGS is to be applied.

### SUMMARY OF THE INVENTION

Exemplary embodiments of the present invention provide apparatuses and methods to reduce the size of residual data when encoding/decoding an FGS layer of a low-pass frame such as an I-frame or a P-frame.

Additional aspects and features of the invention will be set forth in part in the description which follows and in part will become apparent to those having ordinary skill in the art upon examination of the following or may be learned from practice of the invention.

In one aspect of the present invention there is provided a method of encoding residual data that constitutes a fine granularity scalable layer between an enhancement layer and a lower layer in a multilayer video signal, which may include reconstructing original data of the lower layer that corresponds to a low-pass frame represented by the FGS layer, obtaining a residual between original data of the enhancement layer and the reconstructed original data of the lower layer, and generating an FGS-layer bitstream through processes of quantizing the residual and performing an entropy coding of the quantized residual.

In another aspect of the present invention, there is provided a method of decoding original data using residual data that constitutes a fine granularity scalable layer between an enhancement layer and a lower layer in a multilayer video signal, which may include generating the residual data through processes of performing an entropy decoding and an inverse quantization of a bitstream of a low-pass frame represented by the FGS layer, reconstructing original data of the lower layer that corresponds to the FGS layer, and reconstructing data of the FGS layer by adding the residual data to the reconstructed original data of the lower layer.

In still another aspect of the present invention, there is provided an encoder for encoding residual data that constitutes a fine granularity scalable layer between an enhancement layer and a lower layer in a multilayer video signal, which may include a residual data generation unit generating residual data of the FGS layer, a lower-layer reconstruction unit reconstructing original data of the lower layer that corresponds to the FGS layer, and a frame discrimination unit providing the original data of the lower layer reconstructed by the lower-layer reconstruction unit to the residual data generation unit if a frame represented by the FGS layer is a low-pass frame.

In still another aspect of the present invention, there is provided a decoder for decoding original data using residual data that constitutes a fine granularity scalable layer between an enhancement layer and a lower layer in a multilayer video signal, which may include a data reconstruction unit reconstructing data of the FGS layer from residual data generated through processes of performing an entropy decoding and an inverse quantization of a bitstream of the FGS layer, a lower-layer reconstruction unit reconstructing original data of the lower layer that corresponds to the FGS layer, and a frame discrimination unit providing the original data of the lower-layer reconstructed by the lower-layer reconstruction unit to the data reconstruction unit if a frame represented by the FGS layer is a low-pass frame.

### BRIEF DESCRIPTION OF THE DRAWINGS

The above and other features and aspects of the present invention will become more apparent from the following detailed description taken in conjunction with the accompanying drawings, in which:

FIG. 1 is a view illustrating an example of a scalable video codec using a multilayer structure FIG. 1;

FIG. 2 is a view schematically illustrating three prediction methods;

FIG. 3 is a view illustrating a residual prediction in a video coding process;

FIG. 4 is a view schematically illustrating a process of coding FGS residual data based on the residual prediction of FIG. 3;

FIG. 5 is a view illustrating a process of selectively performing a residual prediction coding method and an intra-BL coding method that refers to a base layer in an FGS-layer coding process according to an exemplary embodiment of the present invention;

FIG. 6 is a view illustrating an encoding process according to an exemplary embodiment of the present invention;

FIG. 7 is a view illustrating a decoding process according to an exemplary embodiment of the present invention;

FIG. 8 is a block diagram illustrating the construction of an FGS encoding unit of a video encoder according to an exemplary embodiment of the present invention; and

FIG. 9 is a block diagram illustrating the construction of an FGS decoding unit of a video decoder according to an exemplary embodiment of the present invention.

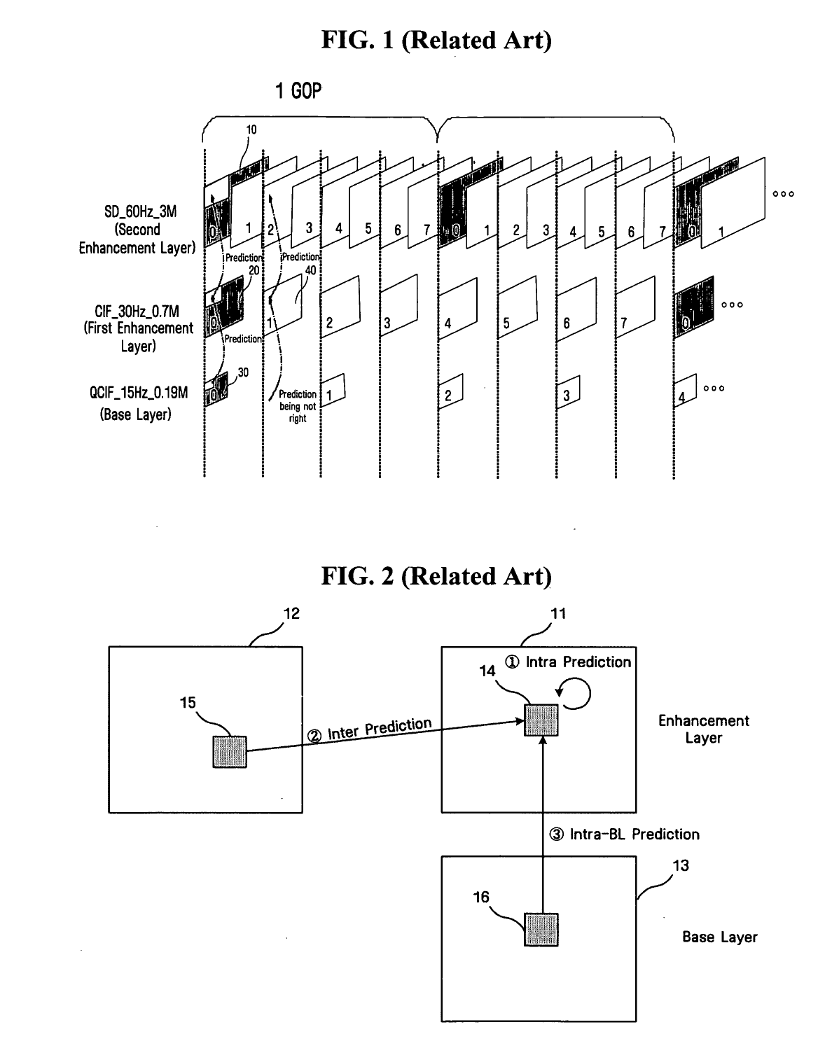

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments . However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the whole description of the present invention, the same drawing reference numerals are used for the same elements across various figures.

Exemplary embodiments of the present invention will be described with reference to the accompanying drawings illustrating block diagrams and flowcharts for explaining a method and apparatus for encoding/decoding an FGS layer using reconstructed data of a lower layer according to exemplary embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide steps for implementing the functions specified in the flowchart block or blocks.

Also, each block of the flowchart illustrations may represent a module, segment, or portion of code, which comprises one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

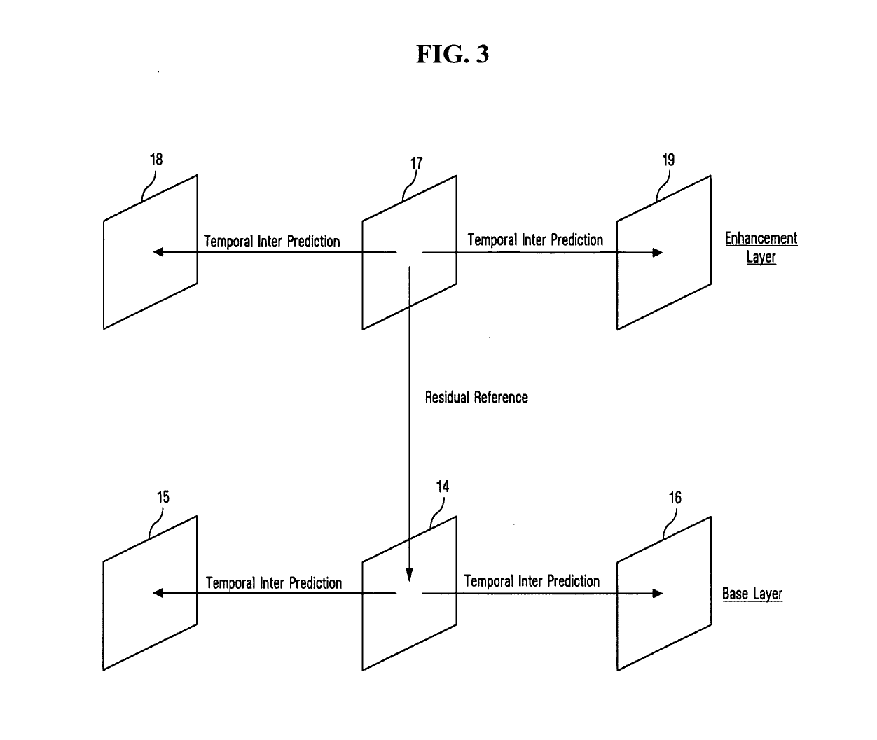

FIG. 3 is an view illustrating a residual prediction in a video coding process. The residual prediction is a process to perform a prediction with respect to residual data that is the result of one of the prediction methods shown in FIG. 2. One macroblock, slice, or frame 14 of a base layer can be constructed from the residual data using temporal inter prediction, which is one of the prediction methods illustrated in FIG. 2. In this case, a macroblock, slice, or frame of an enhancement layer that refers to the base layer can also be constructed through a residual prediction that refers to the residual data of the base layer. Hereinafter, the invention will be explained using macroblocks, but the present invention is not limited to macroblocks. The present invention can also be applied to slices or frames.

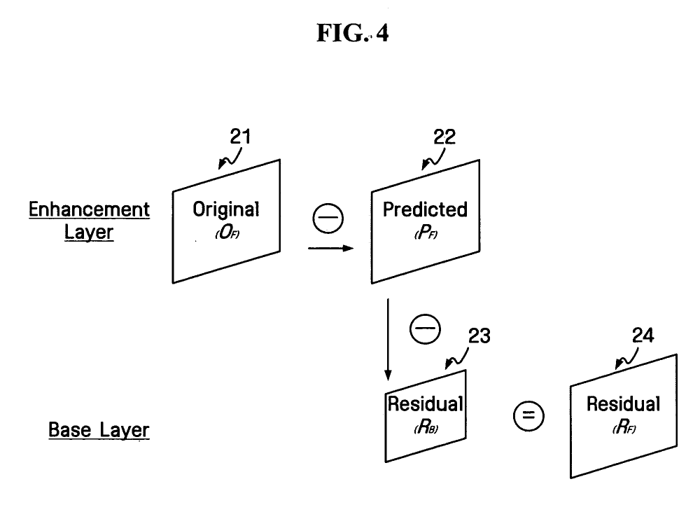

FIG. 4 is a view schematically illustrating a process of coding FGS residual data based on a residual prediction of FIG. 3. In the joint scalable video model (JSVM), FGS is obtained through a process of subtracting predicted data from the original data of a video, and then subtracting the residual data of a lower level (i.e., base layer) from the subtracted data once more. This can reduce the size of the residual data since the residual data of the base layer is not greatly different from the residual data of an upper layer according to FGS.

The FGS layer may exist between the base layer and the enhancement layer. In addition, if two or more enhancement layers exist, it may exist between the lower layer and the upper layer. In the following description, the current layer means the enhancement layer and the base layer is used as an example of the lower layer. However, this is merely exemplary, and the present invention is not limited thereto.

If it is assumed that O_{F}, P_{F} and R_{F} are original data, predicted data and residual data of the current layer, respectively, and O_{B}, P_{B} and R_{B} are original data, predicted data and residual data of the base layer, respectively, a process of obtaining R_{F} is expressed as:
R_{F}=O_{F}−P_{F}−R_{B}=(O_{F}−P_{F})−R_{B} (1)

The difference between the predicted data of the current layer and the original data is obtained by subtracting the predicted data from the original data. In the case where data 23 of the lower layer (i.e., base layer) has the residual data that refers to another data of the base layer, it has the similarity to the residual data of the enhancement layer (i.e., current layer) in consideration of the correlation between the enhancement layer and the base layer. Accordingly, in order to obtain the residual data 24, the residual data 23 of the base layer is referred to.

In the JSVM, two inter-layer coding methods exist. First is a residual prediction that is determined by a rate-distortion (RD) cost function. Second is an intra-BL coding that uses macroblocks of the base layer. An FGS coding process is similar to the residual prediction method that is the first method. However, if the macroblock of the base layer is an intra macroblock, it is efficient to use the intra-BL coding as the FGS coding process. This is because, in the case of the intra macroblock, the size of the residual data between the reconstructed base layer and the original data is small.

The intra-BL coding can be expressed by:
O_{F}−O_{B}=O_{F}−D(P_{B}+R_{B}) (2)

Here, D denotes a deblocking filter. In particular, since the residual data of the low-pass frame is subject to a directional intra prediction and refers to a frame temporarily farther apart from the low-pass frame, many block artifacts exist. Accordingly, it brings a better result to perform the residual prediction from the base layer rather than to perform the residual prediction coding.

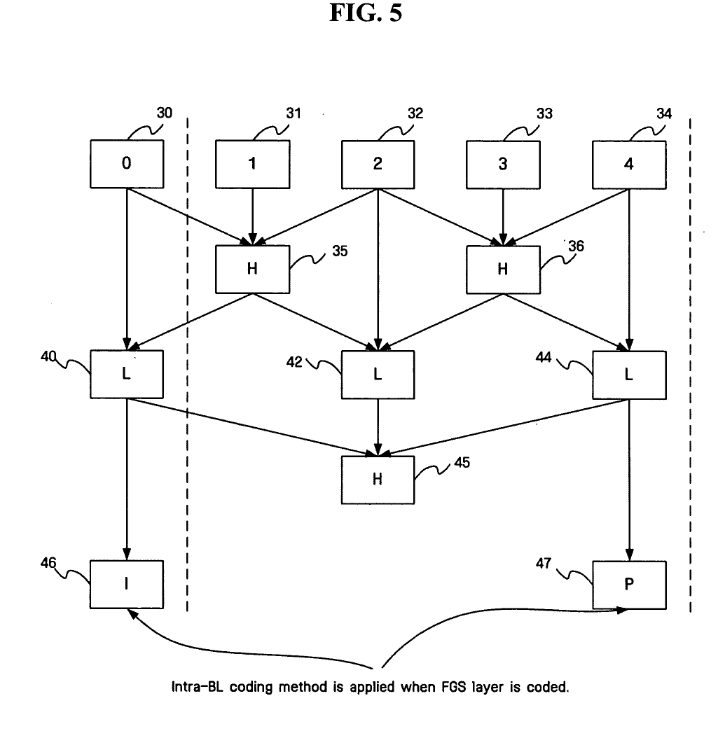

FIG. 5 is a view illustrating a process of selectively performing a residual prediction coding method and an intra-BL coding method that refers to a base layer in an FGS-layer coding process according to an exemplary embodiment of the present invention.

In FIG. 5, numerals “30” to “34” indicate video signals that include the original video, which may be in the unit of a macroblock, slice or frame. In the exemp;ary embodiment of the present invention, the video signals are in the unit of a frame as shown in FIG. 5. The video signals are input to high pass filters, and H-frames 35 and 36 are obtained from the high pass filters. The H-frame 35 is a frame obtained by passing the video signals 30, 31 and 32 through the high pass filters, and H-frame 36 is a frame obtained by passing the video signals 32, 33 and 34 through the high pass filter. Then, L-frames 40, 42 and 44 are obtained by passing the H-frames through low pass filters, and then H-frame 45 is obtained by passing the L-frames through a high pass filter. I-frame 46 and P-frame 47, which have intrablocks, are extracted from the L-frames. Here, since the H-frames 35, 36 and 45 are obtained through the high pass filters, the existing residual prediction coding can be used for the H-frames. However, since the I-frame 46 and the P-frame 47 are apart from frames that should be referred to for the temporal calculation of the residual or are obtained through the directional intra coding, the intra-BL coding is used for the I and P-frames in the case of coding the FGS layers of the I and P-frames. Accordingly, the FGS layer is given by:
R_{F}=O_{F}−O_{B} (3)

In the case where the current frame is a low-pass frame, the residual of the base-layer data is obtained from the original data when the residual data of the FGS layer is coded. In the case where the current data is not the low-pass filter, the conventional coding method is used as explained in Equation (1).

O_{B} can be obtained from the predicted data using the residual data. A process of obtaining O_{B} is expressed as:
O_{B}=D(P_{B}+R_{B}) (4)

In order to obtain O_{B}, deblocking is performed with respect to the result obtained by adding the residual data R_{B} to the predicted data P_{B}. In this case, a deblocking coefficient D is applied. Since the deblocking is performed in the FGS process, an over-smoothing can be reduced by weakening the deblock, and thus the deblocking coefficient can be set to “1”.

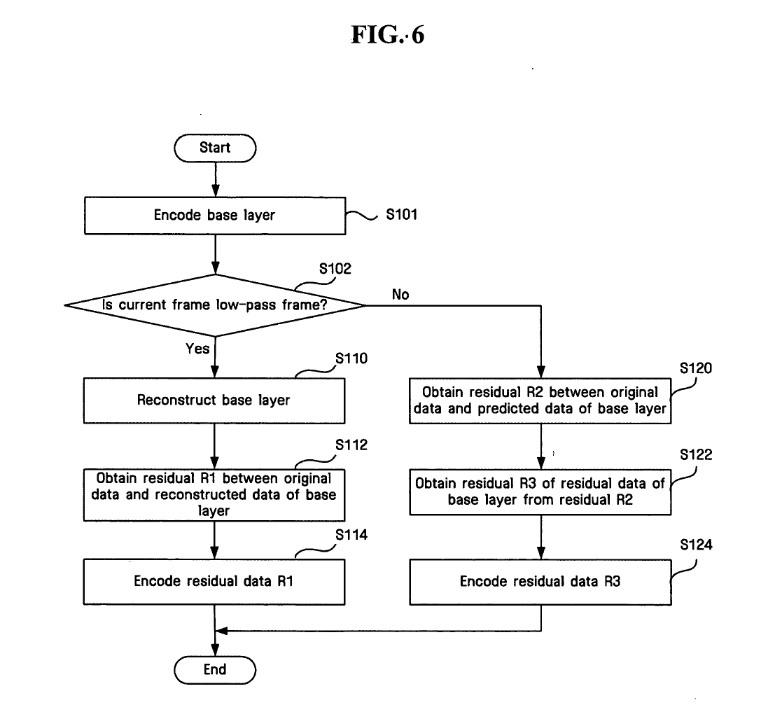

FIG. 6 is a view illustrating an encoding process according to an exemplary embodiment of the present invention.

First, the base layer is coded S101. Then, it is determined whether the current frame is a low-pass frame S102. The low-pass frame may be an I-frame or P-frame. In the case of the low-pass frame, the base layer is reconstructed S110. This means the reconstruction of the base layer, and corresponds to the obtaining of O_{B} in Equation (3). Then, the residual R1 between the original data and the reconstructed data of the base layer is obtained S112, and then the obtained residual R1 is coded S114. If the current frame is not the low-pass frame in S102, the conventional FGS coding method is performed. As a result, the residual R2 between the original data and the predicted data of the base layer is obtained S120. Then, the residual R3 that exists between R2 calculated in S120 and the residual data of the base layer is obtained S122, and then the residual data R3 is coded S124.

In order for a video decoder to decode the data encoded through the above-described process, it is confirmed whether the frame to be decoded is the low-pass frame. Then, the original data is obtained by performing the decoding according to the result of the confirmation.

The data that is received when the decoding is performed is the residual data, and the data to be reconstructed is the original data as described above. Accordingly, in the case where the frame to be decoded is the low-pass frame, the work that should be done at the decoding end is expressed as:
O_{F}=R_{F}+O_{B} (5)

R_{F} and O_{B} are data that are transmitted in a decoding process or obtained through the transmitted data. The process of setting the deblocking coefficient to “1” as described above can also be applied to the decoding process. As expressed in Equation (4), the deblocking coefficient can be set to “1” as O_{B} is generated using the two received data P_{B} and R_{B}. Operation S110 of FIG. 6 can proceed by setting the deblocking coefficient to “1”.

If the data to be decoded is not the low-pass frame, a typical decoding process is performed as expressed in Equation (6).
O_{F}=R_{F}+P_{F}+R_{B} (6)

Accordingly, the original data can be obtained by adding the residual data of the base layer to the predicted data and the residual data of the current layer.

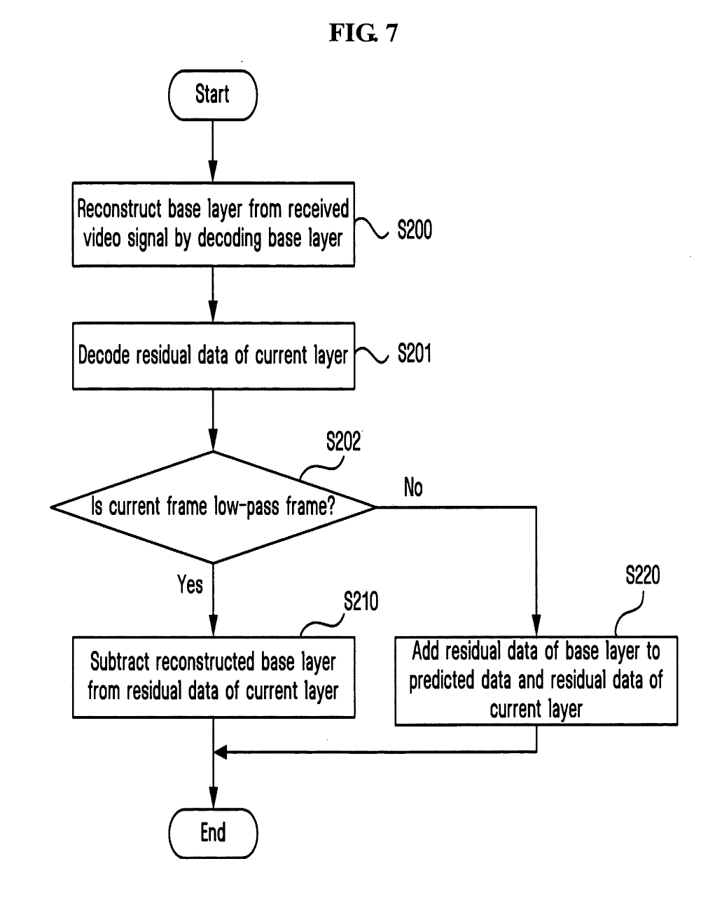

FIG. 7 is an view illustrating a decoding process according to an exemplary embodiment of the present invention.

The base layer is reconstructed from the received video signal by decoding the base layer S200, and the residual data of the current layer is decoded S201. In the case where the current frame is the low-pass frame S202, the result obtained by subtracting the reconstructed base layer data from the residual data of the current layer as Equation (5) is considered as data of the current layer S210. By contrast, if the current frame is not the low-pass frame, the data of the current layer is obtained by adding the residual data of the base layer to the predicted data and the residual data of the current layer as Equation (6) S220.

In the exemplary embodiment of the present invention, the term “unit”, “module” or “table”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented so as to execute one or more CPUs in a device.

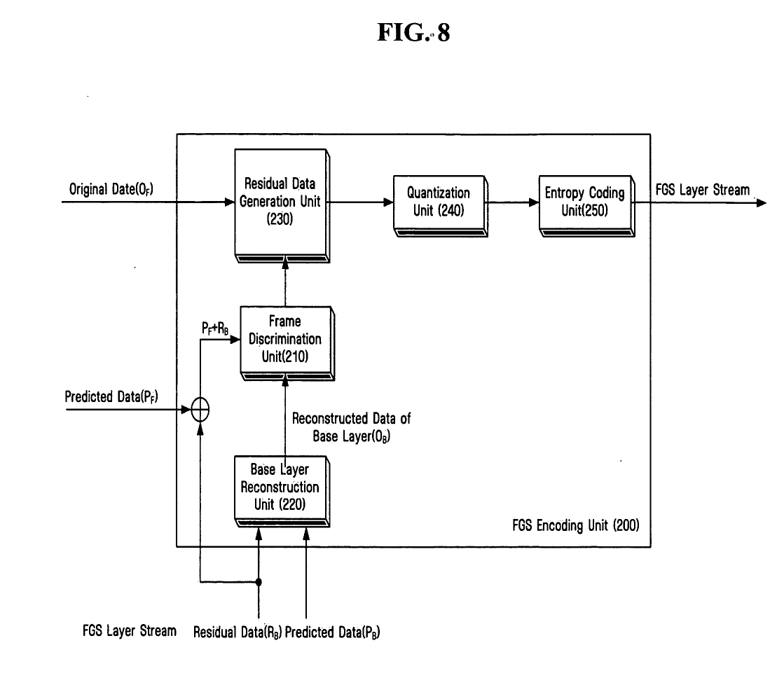

FIG. 8 is a block diagram illustrating the construction of an FGS encoding unit of a video encoder according to an exemplary embodiment of the present invention.

An FGS encoding unit 200 receives the original data O_{F} of the current layer, the predicted data P_{F} of the current layer, the residual data R_{B} of the base layer, and the predicted data P_{B} of the base layer.

A frame discrimination unit 210 discriminates whether the current frame is the low-pass frame, and selects whether to use the conventional residual prediction coding method or the intra-BL coding method in order to generate the residual data R_{F} of the current layer in accordance with the result of discrimination. Two values of P_{F}+R_{B} and O_{B} are input to the frame discrimination unit 210. In the case of the low-pass frame, the frame discrimination unit selects and transfers the original data O_{B} of the base layer to a residual data generation unit 230. In the case where the current frame is not the low-pass frame, the frame discrimination unit transfers the result obtained by adding the residual data R_{B} of the base layer to the predicted data P_{F} of the current layer to the residual data generation unit 230. The residual data generation unit 230 generates the residual data by calculating the difference between the value transferred from the frame discrimination unit 210 and the original data O_{F}.

In the case of the low-pass frame, a base-layer reconstruction unit 220 reconstructs the original data of the base layer so that the intra-BL coding can be performed in the FGS coding process. The reconstruction may refer to Equations (3) and (4). In this case, as expressed in Equation (4), the reconstructed original data O_{B} of the base layer can be obtained by setting the deblocking coefficient D for the residual data R_{B} and the predicted data P_{B} of the base layer to “1”.

A quantization unit 240 quantizes transform coefficients generated by the residual data generation unit 230. The quantization means representing the transform coefficients expressed as real values by discrete values by dividing the transform values at predetermined intervals from a quantization table, and matching the discrete values to corresponding indexes. The resultant values quantized as above are called quantized coefficients.

The entropy coding unit 250 performs lossless coding of the quantized coefficients generated by the quantization unit 240 and generates an FGS-layer bitstream. Huffman coding, arithmetic coding, or variable length coding may be used as the lossless coding method.

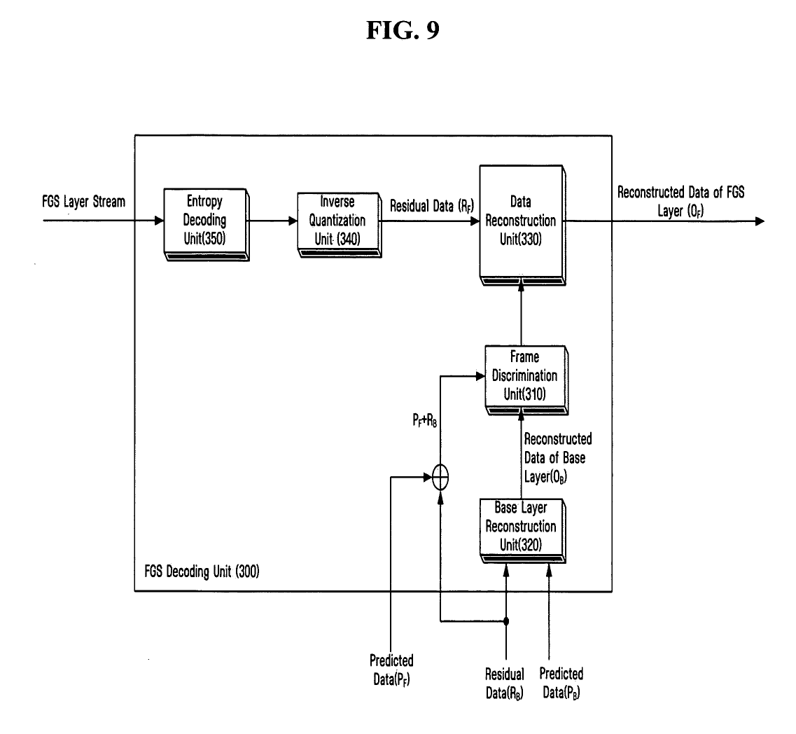

FIG. 9 is a block diagram illustrating the construction of an FGS decoding part of a video decoder according to an exemplary embodiment of the present invention.

The stream of the FGS layer in the received video signal is decoded through an entropy decoding unit 350. The entropy decoding unit 350 extracts texture data from the FGS-layer bitstream by performing a lossless decoding of the FGS-layer bitstream.

An inverse quantization unit 340 inversely quantizes the texture data. This inverse quantization process is the inverse process of the quantization process performed by the FGS encoding unit 200, which reconstructs the matching values from the indexes generated in the quantization process using the quantization table used in the quantization process.

A data reconstruction unit 330 adds the value transferred from the frame discrimination unit 310 to the residual data R_{F}, and generates the reconstructed data O_{F} of the FGS layer.

A frame discrimination unit 310 discriminates whether the current frame is the low-pass frame, and selects whether to use the conventional residual prediction decoding method or the intra-BL decoding method in order to generate the reconstructed data O_{F} of the current layer in accordance with the result of discrimination. Two values of P_{F}+R_{B} and O_{B} are input to the frame discrimination unit 310. In the case of the low-pass frame, the frame discrimination unit selects and transfers the original data O_{B} of the base layer to the data reconstruction unit 330. In the case where the current frame is not the low-pass frame, the frame discrimination unit transfers the result obtained by adding the residual data R_{B} of the base layer to the predicted data P_{F} of the current layer to the data reconstruction unit 330. The data reconstruction unit 330 reconstructs the original data O_{F} by adding the residual data R_{F} to the value transferred from the frame discrimination unit 210.

In the case of the low-pass frame, a base-layer reconstruction unit 320 reconstructs the original data of the base layer so that the intra-BL coding can be performed in the FGS decoding process. The reconstruction may refer to Equations (4) and (5). In this case, as expressed in Equation (4), the reconstructed original data O_{B} of the base layer can be obtained by setting the deblocking coefficient D for the residual data R_{B} and the predicted data P_{B} of the base layer to “1”.

As described above, according to the exemplary embodiments of the present invention, the size of the residual data can be reduced when an FGS layer of a low-pass frame such as an I-frame or a P-frame is encoded and decoded.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method of encoding residual data that constitutes a fine granularity scalable (FGS) layer between an enhancement layer and a lower layer in a multilayer video signal, the method comprising:
reconstructing original data of the lower layer that corresponds to a low-pass frame represented by the FGS layer;
obtaining residual data between original data of the enhancement layer and reconstructed original data of the lower layer; and
generating an FGS-layer bitstream through quantizing the residual data and performing an entropy coding of the quantized residual data.

2. The method of claim 1, wherein the low-pass frame is an I-frame.

3. The method of claim 1, wherein the reconstructing original data of the lower layer involves adding predicted data of the lower layer to the residual data of the lower layer.

4. The method of claim 3, wherein the reconstructing original data of the lower layer further includes setting a deblocking coefficient for the deblocking to “1” and performing a deblocking of a result of the addition.

5. A method of decoding original data using residual data that constitutes a fine granularity scalable (FGS) layer between an enhancement layer and a lower layer in a multilayer video signal, the method comprising:
generating residual data through performing an entropy decoding and an inverse quantization of a bitstream of a low-pass frame represented by the FGS layer;
reconstructing original data of the lower layer that corresponds to the FGS layer; and
reconstructing data of the FGS layer by adding the residual data to reconstructed original data of the lower layer.

6. The method of claim 5, wherein the low-pass frame is an I-frame.

7. The method of claim 5, wherein the reconstructing original data of the lower layer involves adding predicted data of the lower layer to the residual data of the lower layer.

8. The method of claim 7, wherein the reconstructing original data of the lower layer further includes setting a deblocking coefficient for the deblocking to “1” and performing a deblocking of a result of the addition.

9. An encoder for encoding residual data that constitutes a fine granularity scalable layer between an enhancement layer and a lower layer in a multilayer video signal, the encoder comprising:
a residual data generation unit which generates residual data of the FGS layer;
a lower-layer reconstruction unit which reconstructs original data of the lower layer that corresponds to the FGS layer; and
a frame discrimination unit which provides the original data of the lower layer reconstructed by the lower-layer reconstruction unit to the residual data generation unit if a frame represented by the FGS layer is a low-pass frame.

10. The encoder of claim 9, wherein the low-pass frame is an I-frame.

11. The encoder of claim 9, wherein the lower-layer reconstruction unit adds predicted data of the lower layer to the residual data of the lower layer.

12. The encoder of claim 11, wherein a deblocking coefficient for the deblocking is set to “1” and the lower-layer reconstruction unit performs a deblocking of a result of the addition.

13. A decoder for decoding original data using residual data that constitutes a fine granularity scalable layer between an enhancement layer and a lower layer in a multilayer video signal, the decoder comprising:
a data reconstruction unit which reconstructs data of an FGS layer from residual data generated through performing an entropy decoding and an inverse quantization of a bitstream of the FGS layer;
a lower-layer reconstruction unit which reconstructs original data of the lower layer that corresponds to the FGS layer; and
a frame discrimination unit which provides the original data of the lower-layer reconstructed by the lower-layer reconstruction unit to the data reconstruction unit if a frame represented by the FGS layer is a low-pass frame.

14. The decoder of claim 13, wherein the low-pass frame is an I-frame.

15. The decoder of claim 13, wherein the lower-layer reconstruction unit adds predicted data of the lower layer to the residual data of the lower layer.

16. The decoder of claim 15, a deblocking coefficient for the deblocking is set to “1” and the lower-layer reconstruction unit performs a deblocking of a result of the addition.

17. A system for encoding residual data that constitutes a fine granularity scalable layer between an enhancement layer and a lower layer in a multilayer video signal, the system comprising:
means for generating residual data of the FGS layer;
means for reconstructing original data of the lower layer that corresponds to the FGS layer; and
means for providing the original data of the lower layer reconstructed by the lower-layer reconstruction unit to the residual data generation unit if a frame represented by the FGS layer is a low-pass frame.

18. The system of claim 17, wherein the low-pass frame is an I-frame.

19. The system of claim 17, wherein the means for reconstructing original data of the lower layer adds predicted data of the lower layer to the residual data of the lower layer.

20. The encoder of claim 19, wherein a deblocking coefficient for deblocking is set to “1” and the means for reconstructing original data of the lower layer performs a deblocking of a result of the addition.

21. A system for decoding original data using residual data that constitutes a fine granularity scalable layer between an enhancement layer and a lower layer in a multilayer video signal, the decoder comprising:
means for reconstructing data of an FGS layer from residual data generated through performing an entropy decoding and an inverse quantization of a bitstream of the FGS layer;
means for reconstructing original data of the lower layer that corresponds to the FGS layer; and
means for providing the original data of the lower-layer reconstructed by the lower-layer reconstruction unit to the data reconstruction unit if a frame represented by the FGS layer is a low-pass frame.

22. The system of claim 21, wherein the low-pass frame is an I-frame.

23. The system of claim 21, wherein the means for reconstructing original data of the lower layer adds predicted data of the lower layer to the residual data of the lower layer.

24. The system of claim 23, wherein a deblocking coefficient for deblocking is set to “1” and the means for reconstructing original data of the lower layer performs a deblocking of a result of the addition.
